(19) United States
(12) Patent Application Publication
(10) Pub. No.: US 2014/0116124 A1
(43) Pub. Date: May 1, 2014

(54) VIBRATION MONITORING

(71) Applicants: Xiaoqin Ma, Nottingham (GB); Daniel Edwards, Nottingham (GB)

(72) Inventors: Xiaoqin Ma, Nottingham (GB); Daniel Edwards, Nottingham (GB)

(73) Assignee: ROMAX TECHNOLOGY LIMITED, Nottingham (GB)

(21) Appl. No.: 14/126,534

(22) PCT Filed: Jun. 15, 2012
(86) PCT No.: PCT/GB2012/051389

§ 371 Date: Dec. 16, 2013

(30) Foreign Application Priority Data
Jun. 15, 2011 (GB) 1110048.4

(51) Int. Cl. G01M 15/14

(52) U.S. Cl. CPC G01M 15/14
USPC 73/112.01

(57) ABSTRACT

A health index (124) can be determined from vibration signatures (108, 110, 112, 114) arising out of an analysis of vibration data (102, 104, 106) by using a combination of frequency analysis (e.g. crest factor, side-band factor) and analyses done in time domain. The health index (124) can thus be calculated by summing a product of one or more of these vibration signatures (108, 110, 112, 114) and a corresponding weighting factor (116, 118, 120, 122).

The present invention relates to methods for identifying a wind or water turbine or a component thereof for maintenance. In particular it relates to a method for analysing vibration data to determine a health index.

Vibration is commonly-measured by Condition Monitoring Systems. Generally speaking, a large vibration compared to a norm is indicative of damage.

Vibration analysis generally relies on a measurement provided by a sensor exceeding a predetermined threshold, which is prone to false alarms if the threshold is set too low. The threshold level is not necessarily constant and may vary with frequency (and hence speed). The presence of shocks and extraneous vibrations means that the threshold level must be set sufficiently high to minimise the risk of false-alarms. Furthermore, the threshold must be sufficiently high to avoid any negative effects caused by ‘creep’ in sensor performance which may occur over its lifetime. In addition, there is no discrimination between vibrations associated with failure or damage and those which are not indicative of failure or damage. The level of vibration can be compared with historical baseline values such as former start-ups and shutdowns.

Faults developing during operation, such as an imbalance in the rotor, can create loads on a bearing in excess of that expected resulting in a reduction in its design life. Incipient faults, such as unbalance, can be detected from analysis of vibration signatures. This gives the magnitude of an imbalance, and an excitation force due to imbalance is a function of the magnitude of the imbalance and square of the speed. An excitation force due to faults can thus be calculated from field operational conditions and used to calculate individual component loads. Deviation from the assumed operating profile can be addressed by using a generic wind simulation model to determine load at the turbine shaft, which allows individual component load based on the field operational conditions to be calculated. Combining these gives the total load at each component, which can be is used to estimate the remaining life of the individual components and the life of the gearbox.

However, shortcomings in wind simulation models mean that the load at the turbine shaft may not be reliably or accurately determined.

According to a first aspect of the invention, there is provided a method for identifying a wind or water turbine or component thereof for maintenance, the method comprising the steps of: analysing vibration data for the wind or water turbine or component thereof thereby providing one or more vibration signatures; determining a health index from the one or more vibration signatures; and comparing the health index with maintenance threshold values. This means that, compared to conventional vibration analysis used in Condition Monitoring Systems, a more useful threshold value is set, which consequently allows a more accurate identification of components requiring maintenance.

Preferably, the step of determining a health index comprises summing a product of the one or more vibration signatures and a corresponding weighting factor. The use of multiple vibration signatures, and a corresponding weighting, means that a more accurate picture of the health of the turbine or component is obtained.

Preferably, the vibration signature comprises a crest factor or a sideband factor.

Preferably, identifying a wind or water turbine or component thereof for maintenance comprises identifying a wind or water turbine or component thereof having a health index above the maintenance threshold. This means that the turbine operator can be notified of turbines or component likely to require maintenance.

Preferably, maintenance includes down-rating the turbine, investigating the turbine or component thereof, and/or replacing or repairing the turbine or component thereof.

Also provided is a storage medium encoded with instructions that, when executed by a processor, perform: analysing vibration data for the wind or water turbine or component thereof thereby providing one or more vibration signatures; determining a health index from the one or more vibration signatures; and comparing the health index with maintenance threshold values. Compared to conventional vibration analysis used in Condition Monitoring Systems, a more useful threshold value is set, which consequently allows an automated and more accurate identification of components requiring maintenance.

The present invention will now be described, by way of example only, with reference to the accompanying drawing, in which:

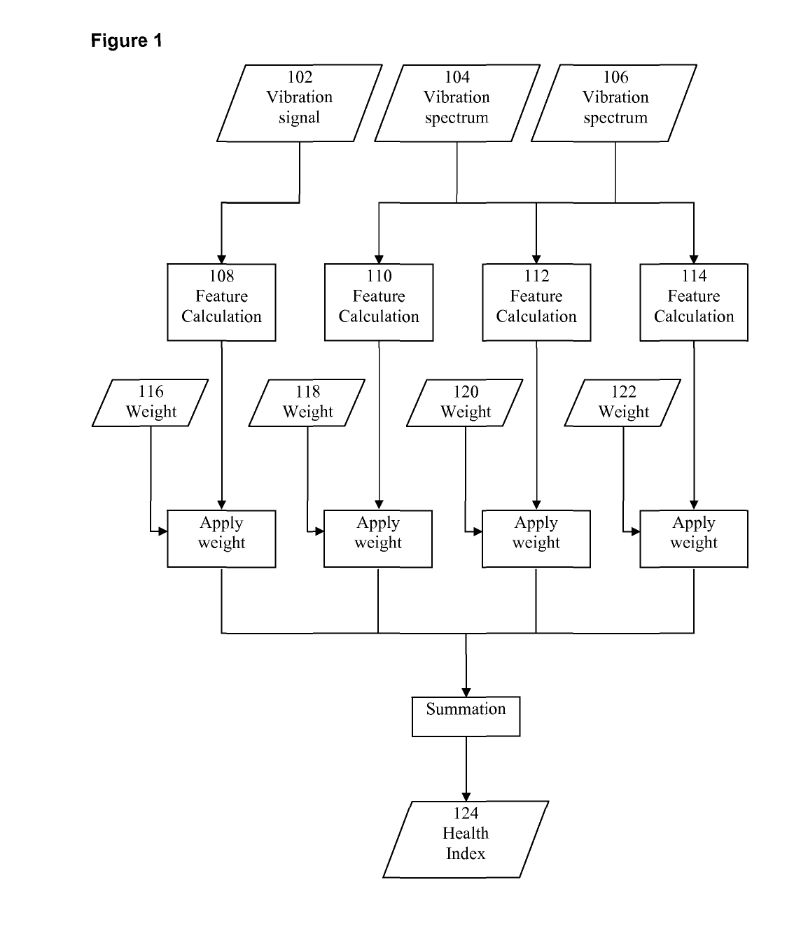

FIG. 1 shows a schematic example of how a Health Index can be calculated;

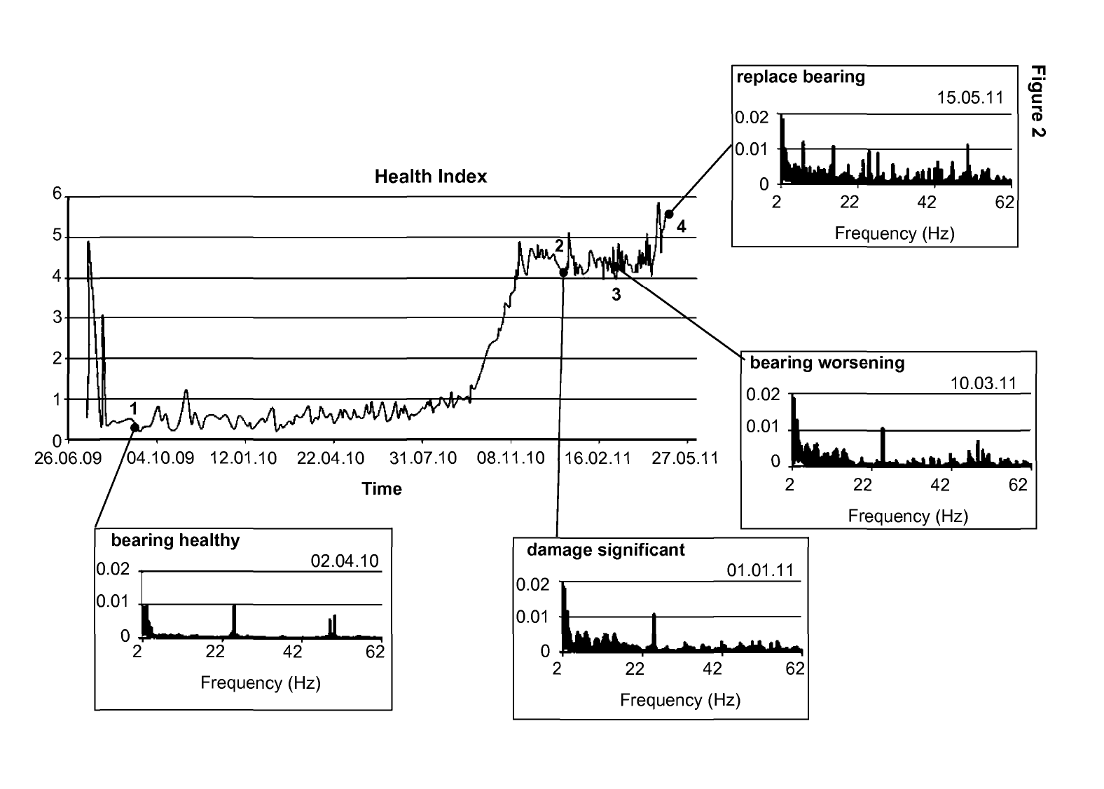

FIG. 2 shows a graph of the variation in a Health Index over time;

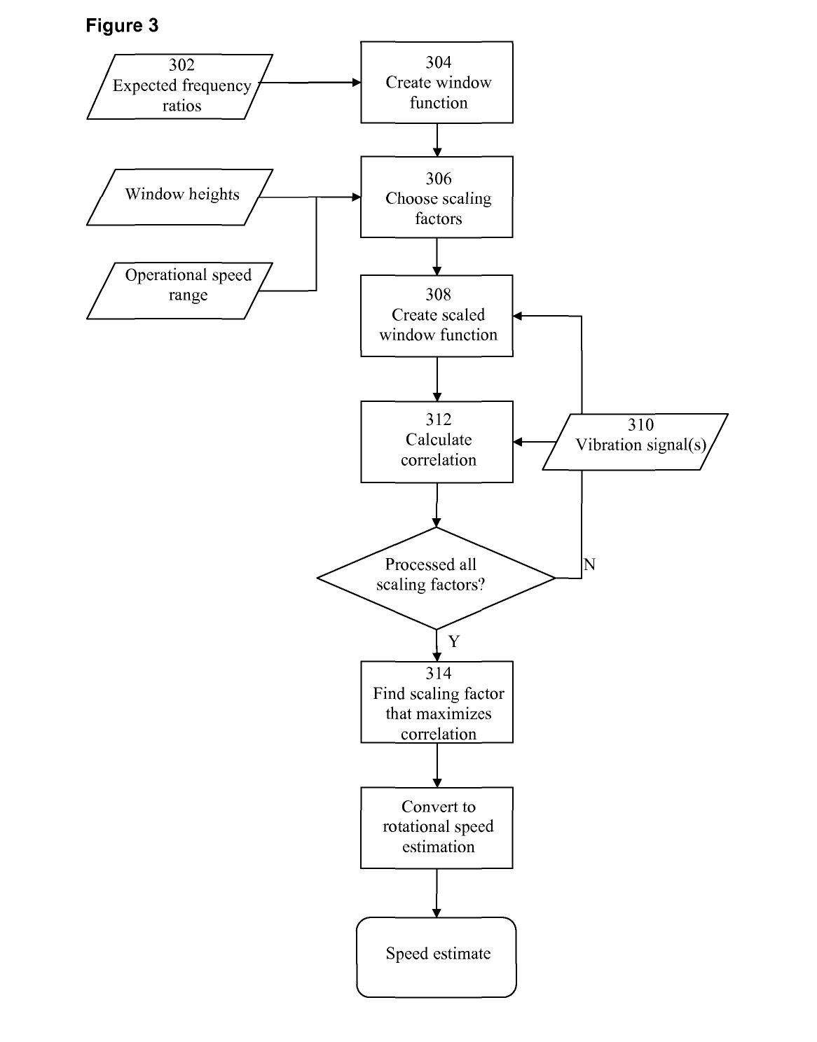

FIG. 3 shows a method for estimating the speed of a turbine component from one or more vibration signals;

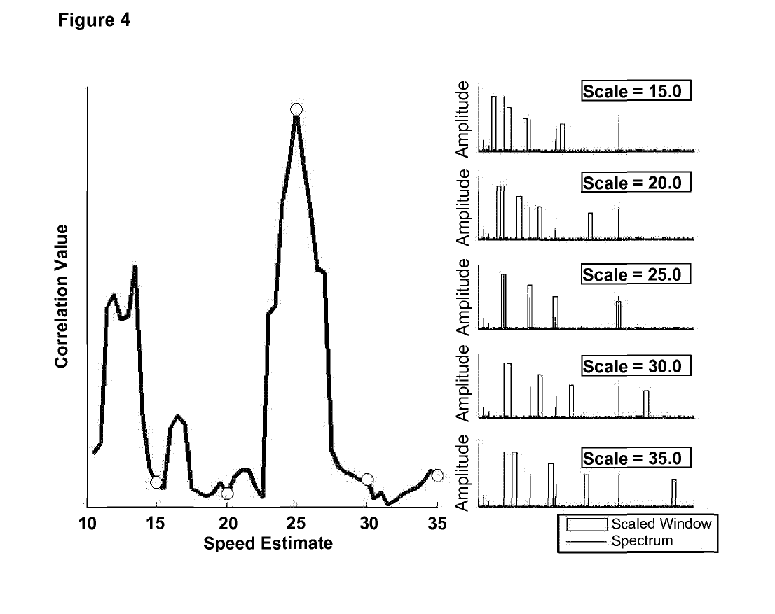

FIG. 4 shows speed estimation based on a single vibration spectrum;

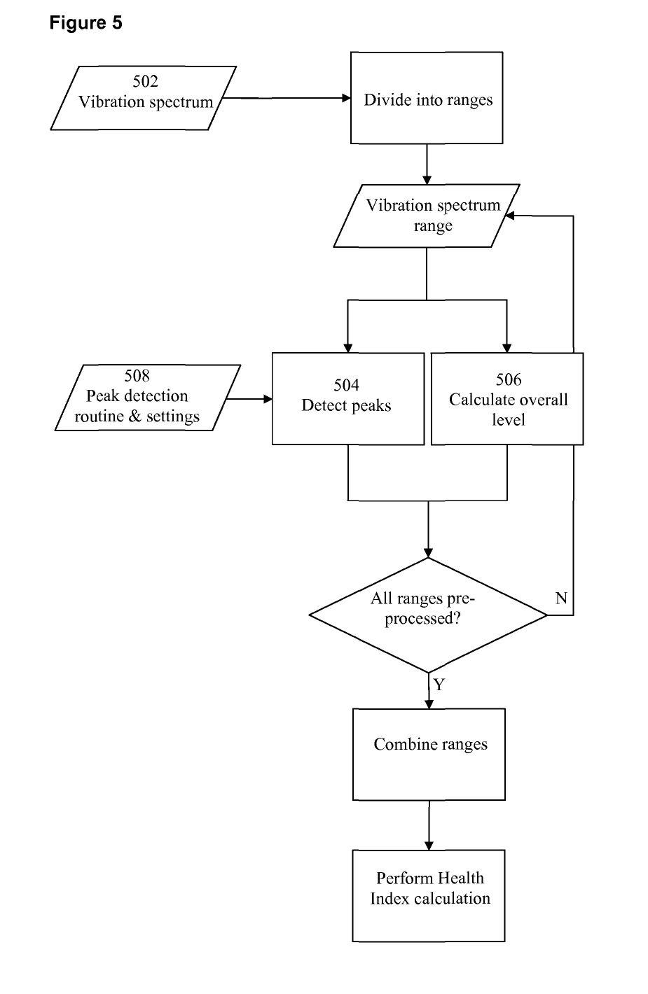

FIG. 5 shows a pre-processing approach for estimating a health index; and

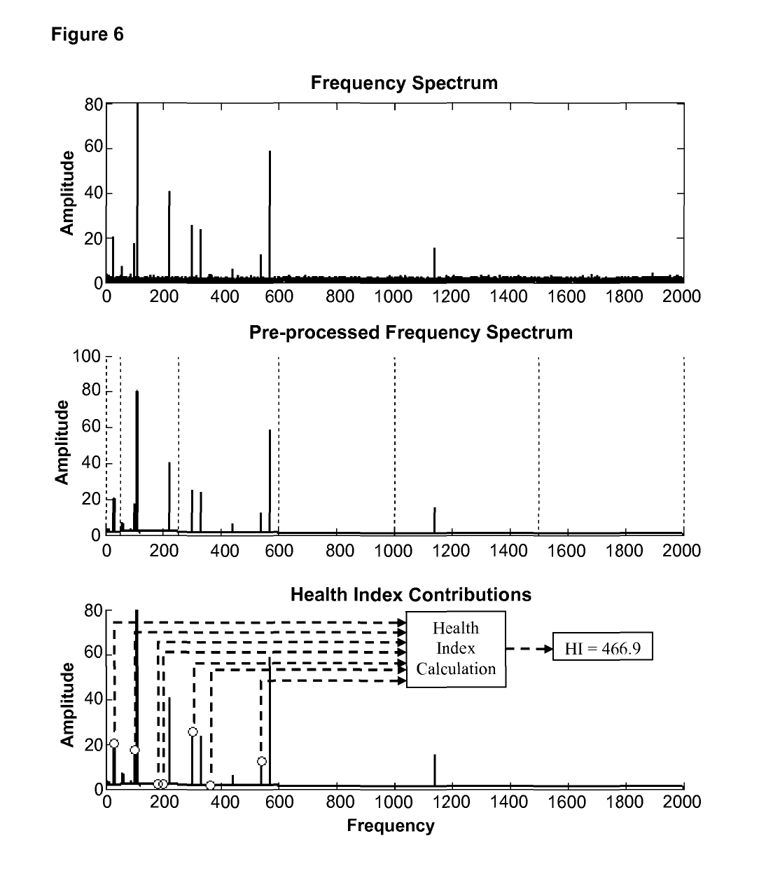

FIG. 6 shows an example of a calculation of a health index calculated from vibration signatures from a single spectrum.

A health index is a single value based on one or more vibration signals and/or frequency domain spectra. It is calculated by extracting features/signatures from the signals and/or spectra, applying a weighting factor to reflect the importance or strength of the feature and then summing the weighted features together. These features are typically the amplitude of a peak in a signal, and might be overall measures from the signal or spectrum such as RMS or kurtosis; be related to the energy present in the signal/spectrum at a particular frequency; or be any other value derived from the vibration signals/spectra. Referring now to FIG. 1, which shows a schematic example of how a Health Index can be calculated, a vibration signal 102 is analysed against a first vibration spectrum 104 and a second vibration spectrum 106. The example shows inputs of one vibration signal and two vibration spectra, this method may be used with any number of vibration time signals and vibration spectra. Feature 108 is calculated from vibration signal 102. Each of the feature calculations may take inputs from one or more of the vibration signals and spectra. Thus features 110,112,114 are calculated from vibration spectra 104,106. The example shows calculations of four separate features; this method may be used with any number of features calculated. In a further step, weights 116,118,120,122 are applied to each feature 108,110,112,114, and the weighted features are summed to give Health Index 124.

A health index can be determined from vibration signatures arising out of an analysis of vibration by using a combination of frequency analysis (e.g. crest factor, side-band factor), analyses done in time domain and so on. The health index (HI) can thus be a function of one or more of these vibration signatures and a corresponding weighting factor, the weighting factor reflecting the importance or strength of the feature in the signature:

HI=f(vibration signatures, weighting factors)

When the vibration is low, then the health index is low, and vice versa.

The features or vibration signatures correspond to the turbine or components thereof, for example, the signatures can relate to a shaft frequency or a gear mesh frequency.

The health index can be stratified, or can be used to set a threshold.

FIG. 2 shows a graph of the variation in a Health Index for a wind turbine component over time.

At point 1, the Health Index is low, and a frequency analysis of the vibration data shows that the wind turbine, or in this case a bearing component thereof, is healthy.

At point 2, the Health Index has increased, and a frequency analysis of the vibration data shows significant damage to the component.

At point 3, a further analysis of the vibration data shows that the condition of the component is worsening.

At point 4, the Health Index has increased further, and a frequency analysis of the vibration data shows indicates that the bearing should be replaced.

Thus it can be seen, in this particular example, that once the Health Index has exceeded a value of about 4, the wind turbine component requires frequent monitoring, and/or the performance of the turbine should be reduced to extend the life of the component into a convenient maintenance window, when it may be inspected and possibly replaced. Once the Health Index has exceeded a value of about 5, the turbine component should be at least inspected and probably repaired or replaced, and/or the turbine stopped.

Thus the process of identifying a wind or water turbine or component thereof for maintenance comprises identifying a wind or water turbine or component thereof having a health index above a maintenance threshold.

Maintenance includes down-rating the turbine, investigating the wind turbine or component thereof, and/or replacing or repairing the wind turbine or component thereof.

The method of vibration monitoring disclosed above is dependent on having an accurate rotational speed value for the wind or water turbine. The present invention also includes a method to estimate a rotating speed of a wind or water turbine based on a frequency spectrum representation of one or more vibration signals that have been measured.

Many components of a wind or water turbine routinely produce vibration energy at distinct frequencies which are proportional to the running speed of the machine. One or more of these frequency ratios is used to estimate the speed from vibration signal(s) by creating a set of windows at the different ratios and adjusting the scaling to maximize the correlation between the windows and the vibration spectra. This is illustrated in FIG. 3, in which expected frequency ratios 302 are used by a create window function 304 to produce the set of windows. For each frequency ratio of interest, an individual window is defined centred on that frequency. This individual window is a function that is a given height at the frequency ratio in question and decreases down to zero away from that frequency ratio. The window function here is the addition/combination of all the individual windows. Scaling factors 306 are chosen and used in step 308 to produce scaled windows that are compared with vibration signals 310 in step 312 to give a correlation value. Scaling factors 306 are adjusted in step 314 to find a scaling factor which maximises the correlation between the scaled windows and vibration signals 310.

This correlation may be the sum or weighted sum of the point-wise multiplication of the vibration spectra and the scaled window function or another method of combining the vibration spectra with the scaled window function. These windows may be rectangular, triangular, Gaussian or any other shape; may have a width that is fixed or proportional to the frequency ratio and/or proportional to the estimated speed and may have variable heights. The window heights are used as weighting factors, which are related to the expected height of the peak—for example if the spectrum had two peaks that indicated the speed consistently with peak A of higher amplitude than peak B then a larger weight would be used on peak B so that their contributions are roughly equivalent. The window scaling factor here is adjusted over the range of operation of the wind or water turbine. Scaling factors are chosen at the lower end of an operational speed range and then adjusted in steps to the upper end of the range to find the maximum correlation in step 314. Frequency ratios can be defined (i.e. what they are a ratio against). If the frequency ratio is defined as a ratio of the frequency to the speed of the shaft of interest, the scaling factor is equal to the speed. On some occasions the speed of a different shaft in the gearbox is required, in which case the scaling factor will have to be multiplied by a ratio to reach the speed. The approach thus yields the most likely rotational speed of the turbine.

This approach is exemplified in FIG. 4, which shows speed estimation based on a single vibration spectrum. The left hand plot shows the change in correlation value as the scaling factor/speed estimate is changed. The right hand plots show the spectrum (solid line) and scaled window function based on four frequency ratios with fixed-width rectangular windows (shaded area) at different scaling factors. In this case the estimated speed is 25.

This method may be used in isolation or in combination with the vibration monitoring presented here or with any other type of wind or water turbine monitoring.

The method of vibration processing can be improved by pre-processing the vibration data before applying the health index calculation. The vibration processing method here may be applied with or without this pre-processing.

A potential drawback of aggregating a number of vibration signatures as disclosed above is that the inherent noise in the vibration signal will overwhelm any features that are present. To mitigate this, the pre-processing approach shown in FIG. 5 may be performed on the frequency spectrum of a vibration signal 502 before the vibration signatures are calculated.

The peak detection algorithm looks for peaks that are a minimum distance apart and it is not sensible to set a single value of this. Usually it is best to try and separate different groups of frequencies that might have different amplitudes by dividing the spectrum into ranges—i.e. shaft frequencies and gear mesh frequencies. And then for each range:
1. Find the frequency location of the peaks in the spectrum 504
2. Find the overall level of the spectrum 506

This allows the spectrum to be reduced to an overall level with a small number of peak values. This method may be used once over the whole frequency domain or a number of times on different ranges in the frequency domain.

The detection of peaks in the spectrum 508 may be performed by standard methods, for example using a set of continuous wavelet transforms to locate the parts of the spectrum that appear most peak-like. The chosen method of detecting peaks may use thresholds or limits to control the number of peaks that are found.

The overall level of the spectrum 506 may be set to zero or may be the mean, RMS value or any other average value based on the amplitudes of the spectrum or range of the spectrum.

FIG. 6 shows an example of a calculation of a health index calculated from vibration signatures from a single spectrum (top panel). The health index may be calculated based on more than one vibration signal and may be based on a time, frequency or other domain representation of the signal.

The spectrum is divided into a number of ranges and the pre-processing is applied to each independently to yield a pre-processed frequency spectrum (middle panel).

The pre-processed spectrum is then used to find the vibration signatures; in this case these are amplitudes of defined frequencies. Then signatures (amplitudes) are then used with weighting factors to calculate the health index (HI).

Once the pre-processing has been performed, the resulting peaks and levels are recombined if necessary and treated as a spectrum for the calculation of health indexes (bottom panel):

HI=Σwᵢ,Aᵢ=(3.0×20.03)+(10.0×14.70)+(5.0×2.35)+(5.0×26.22)+(10.0×2.35)+(5.0×1.66)+(5.0×11.57)=439.6

where HI is Health index, wᵢ is a weight and Aᵢ is an amplitude.

A storage medium encoded with instructions is also provided that, when executed by a processor, perform: analysing vibration data for the wind or water turbine or component thereof thereby providing one or more vibration signatures; determining a health index from the one or more vibration signatures; and comparing the health index with maintenance threshold values.

1-29. (canceled)

30. The method for identifying a wind or water turbine or component thereof for maintenance, the method comprising the steps of:
analysing vibration data for the wind or water turbine or component thereof thereby providing one or more vibration signatures;
determining a health index from the one or more vibration signatures; and
comparing the health index with a maintenance threshold value
in which the step of determining a health index comprises the steps of:
providing corresponding weighting factors for the one or more vibration signatures; and
summing a product of the one or more vibration signatures and the corresponding weighting factor;
identifying a wind or water turbine or component thereof for maintenance having a health index above the maintenance threshold value.

31. The method according to claim 30, in which one or more vibration signatures comprise one or both of:
one or more vibration signals; and
one or more of frequency domain spectra.

32. The method according to claim 31, in which determining a health index comprises the preliminary step of: extracting features from the one or more vibration signatures.

33. The method according to claim 30, in which the vibration signature is one or more of: peak amplitude, RMS, kurtosis, crest factor, sideband factor, and energy present in the vibration data at a particular frequency.

34. The method according to claim 30, in which the health index is a single value based on one or more sets of vibration data.

35. The method according to claim 30, in which the corresponding weighting factors reflect the importance or strength of the vibration signature.

36. The method according to claim 30 in which maintenance includes any of:
down-rating the turbine;
investigating the wind turbine or component thereof; and
replacing or repairing the wind turbine or component thereof.

37. The method according to claim 30, additionally including a first step comprising: processing the vibration data to remove noise interfering with the one or more vibration signatures.

38. The method according to claim 37, in which the step of processing the vibration data comprises the step of:
dividing the vibration data into ranges;
detecting locations of vibration signatures in each range;
calculating values of the vibration signatures;
combining the ranges.

39. The method according to claim 38, in which the step of detecting locations of vibration signatures comprises using a set of continuous wavelet functions.

40. The method according to claim 39, in which the step of detecting locations of vibration signatures comprises use of thresholds or limits to control the number of vibration signatures detected.

41. The method according to any of claim 30, additionally comprising the step of:
providing a rotational speed of a component associated with a vibration signature.

42. The method according to claim 41, in which the step of providing a rotational speed comprises the steps of:
providing expected vibration signatures;
providing for each expected vibration signature a ratio;
multiplying the ratio by a scaling factor;
creating a set of windows for each product of ratio and scaling factor;
adjusting the scaling factor to maximize a correlation between the set of windows and the vibration data;
wherein the scaling factor is a function of the rotational speed.

43. The method according to claim 42, in which the ratio is the ratio of a frequency of an expected vibration signature to a speed of a component of interest.

44. The method according to claim 43, in which the scaling factor is equal to the rotational speed.

45. A computer readable storage medium encoded with instructions that, when executed by a processor, perform:
analysing vibration data for the wind or water turbine or component thereof thereby providing one or more vibration signatures;
determining a health index from the one or more vibration signatures; and
comparing the health index with maintenance threshold values
in which the step of determining a health index comprises the steps of:
providing corresponding weighting factors for the one or more vibration signatures; and
summing a product of the one or more vibration signatures and the corresponding weighting factor;
identifying a wind or water turbine or component thereof for maintenance having a health index above the maintenance threshold value.

46. The method according to claim 45, in which one or more vibration signatures comprise one or both of:
one or more vibration signals; and
one or more of frequency domain spectra.

47. The method according to claim 46, in which determining a health index comprises the preliminary step of: extracting features from the one or more vibration signatures.

48. The method according to claim 45, additionally comprising the step of:
providing a rotational speed of a component associated with a vibration signature.

49. The method according to claim 48, in which the step of providing a rotational speed comprises the steps of:
providing expected vibration signatures;
providing for each expected vibration signature a ratio;
multiplying the ratio by a scaling factor;
creating a set of windows for each product of ratio and scaling factor;
adjusting the scaling factor to maximize a correlation between the set of windows and the vibration data;
wherein the scaling factor is a function of the rotational speed.
